(19) United States
(12) Patent Application Publication
(10) Pub. No.: US 2009/0308859 A1
(43) Pub. Date: Dec. 17, 2009

(54) CERAMIC HEATER AND METHOD OF MANUFACTURING THE SAME

(75) Inventors: Koji KATO, Gunma-ken (JP); Shoji KANO, Gunma-ken (JP)

Correspondence Address: MILLEN, WHITE, ZELANO & BRANIGAN, P.C., 2200 CLARENDON BLVD., SUITE 1400, ARLINGTON, VA, 22201, US

(73) Assignee: Shin-Etsu Chemical Co., Ltd., Tokyo (JP)

(21) Appl. No.: 12/481,980

(22) Filed: Jun. 10, 2009

(30) Foreign Application Priority Data
Jun. 11, 2008 (JP) JP2008-153274

(51) Int. Cl. H05B 3/10; H05B 3/00

(52) U.S. Cl. 219/553; 29/611

(57) ABSTRACT

A ceramic heater is provided and comprises a ceramic substrate and a conductive heating element arranged inside of or on a surface of the ceramic substrate. The conductive heating element is made of a material which had undergone a high-temperature heat treatment.

### TECHNICAL FIELD

The present invention relates to a ceramic heater for heating a semiconductor wafer that is an object to be heated, used for a CVD device, a sputtering device in a manufacturing step for a semiconductor device, or an etching device for etching a generated thin film, or the like, and relates also to a method of manufacturing the same.

### BACKGROUND ART

For a heater used for heating a semiconductor wafer in a manufacturing step for a semiconductor device, there have been used a ceramic heater in which on oxide ceramics, nitride ceramics, or a heat resistant substrate covered with an insulating layer such as an oxide film and a nitride film, there is formed a heating element pattern composed of metals such as nickel, chrome, tantalum, molybdenum, tungsten, and platinum or a conductive ceramic thin film such as silicon carbide and pyrolytic graphite.

To form the heating element pattern, there have been: a method for forming a resistant heating element by a coating method using a method such as a screen print; a method for forming a resistant heating element using a physical vapor deposition such as sputtering or a plating method; or a method for forming a resistant heating element using a chemical vapor deposition.

In the method for forming a resistant heating element by the coating method, a method such as a screen print is used to form the heating-element pattern on the surface of a substrate. However, the print thickness becomes irregular, so does a resistance value of the formed resistant heating element. This may result in a problem that the symmetry of a heater temperature distribution becomes poor.

In the method for forming a resistant heating element by using a physical vapor deposition such as sputtering, a plating method, or a chemical vapor deposition, these methods are firstly used to form a metal layer or a conductive ceramic layer having smaller thickness irregularity on the surface of the substrate. Thereafter, by performing etching processing or sand blast processing or performing laser machining (for example, see JP-A-2006-54125), the heating element is trimmed so as to form a heating-element pattern having a better temperature distribution symmetry. However, when the heating element is thus trimmed, the thickness or the width of the heating pattern is reduced, and this results in a resistance value being larger than the target resistance value.

Upon actually using the heater, a normal-rated voltage or a normal-rated current is determined for a power supply or wiring. Thus, unless the resistance value is contained within a certain range (when there is a large variation from the target resistance value), it is not possible to input sufficient power required for heating by a previously prepared power supply device, and as a result, it may not be possible to heat up to a predetermined target temperature.

Therefore, the heating pattern is firstly produced so that the resistance value is smaller than the target resistance value, and thereafter, the heating pattern is trimmed thereby to perform an adjustment in the temperature distribution by the irregularity of the resistance value or an adjustment for matching to the target resistance value (see Japanese Patent No. 3952875).

When the heating element is trimmed by the sand blast processing, the etching processing, and the laser machining, the adjustment for the irregularity of the resistance value or the adjustment for increasing the resistance value may be possible. However, in contrary thereto, it is difficult to make an adjustment for decreasing the resistance value. Therefore, it is necessary to previously lower the resistance value of the heating element pattern so that the target resistance value is obtained.

### SUMMARY OF INVENTION

### Technical Problem

In view of the problems inherent in the above-described conventional technology, an object of the present invention is to provide a ceramic heater that eliminates the necessity of manufacturing with a low resistance value in advance and is capable of adjusting to a lower value, and also to provide a method of manufacturing the same.

### Solution to Problem

A ceramic heater of the present invention is a ceramic heater comprising: a ceramic substrate and a conductive heating element arranged inside of or on a surface of the ceramic substrate, wherein said conductive heating element is made of a material which had undergone a high-temperature heat treatment. It is preferable as follows: a temperature of the high-temperature heat treatment is in a range of 1000 to 2200° C.; the resistance value of the conductive heating element is 0.1 to 20% lower than that of the same conductive heating element before the heat treatment; the conductive heating element is any one of pyrolytic graphite, boron-containing pyrolytic graphite, and silicon-containing pyrolytic graphite; and the ceramic substrate is oxide ceramics, nitride ceramics, or a heat resistant substrate covered with an insulating layer such as an oxide film or a nitride film.

Also, a method of manufacturing a ceramic heater of the present invention is a method of manufacturing a ceramic heater which comprises a ceramic substrate and a conductive heating element arranged inside of or on a surface of the ceramic substrate, the method comprising a step of adjusting a resistance value of the conductive heating element by performing high-temperature heat treatment. It is preferable that the high-temperature heat treatment of the conductive heating element is performed continuously or simultaneously with a formation processing step of an insulating protective layer.

### ADVANTAGEOUS EFFECTS OF INVENTION

According to the present invention, in a ceramic heater in which a conductive heating element is arranged inside of or on a surface of a ceramic substrate, when a high-temperature heat treatment is performed in a range of 1000 to 2200° C., a resistance value can be downwardly adjusted by 0.1 to 20%. Thus, upon arranging a conductive heating element, it is not necessarily needed to make the resistance value small in advance, an excessive use of a material of the conductive heating element is not needed any more, a cost for forming the conductive heating element can be also lowered.

Further, the high-temperature heat treatment step can be performed continuously or simultaneously with a formation of an insulating ceramic protective layer, and thus, a heater of a desired resistance value can be easily obtained without increasing unnecessary steps.

### BRIEF DESCRIPTION OF THE DRAWING

FIG. 1 is an explanatory schematic diagram showing a ceramic heater according to the present invention.

### DESCRIPTION OF EMBODIMENTS

As a result of extensive studies, the present inventor, et al., have found that when high-temperature heat treatment is performed on a conductive heating element, various characteristics such as the crystallinity of the conductive heating element, the orientation, the crystallite size, and the density are changed, and thereby, a resistance value is changed.

Therefore, the present inventor, et al., carried out high-temperature heat treatments on the conductive heating element in advance under a plurality of conditions, measured the change in resistance value, and based thereon, formed a conductive heating element (pattern). After confirming the resistance value, the present inventor, et al., set heat treatment conditions to carry out the heat treatment, and as a result, confirmed that it would be possible to obtain a desired resistance value.

Further, the present inventor, et al., confirmed that these heat treatments could be processed continuously or processed simultaneously with a formation processing step of an insulating protective film performed to secure the insulation on the conductive heating element.

Hereinafter, a ceramic heater and a method of manufacturing the same, of the present invention, will be described in detail.

According to the present invention, a high-temperature heat treatment is performed on a ceramic heater provided with a conductive heating element inside of or on the surface of a ceramic substrate. Thereby, various characteristics such as the crystallinity of the conductive heating element, the orientation, the crystallite size, and the density are changed, whereby a resistance value of the conductive heating element is adjusted.

The reason why the resistance value is changed is probably due to the following facts: in a conductive heating element produced (formed) by a screen print method, a sputtering method, a plating method, and a CVD method, when the heat treatment is performed, the “crystallinity is changed from non-crystalline to crystalline, and thus, the resistance is decreased”, the “crystalline orientation is changed, and thus, the anisotropy is increased. As a result, electrons become easy to flow in that direction, thereby decreasing the resistance”, “as a result of sintering being occurring among particles, the crystalline size becomes large, and thus, the resistance at a particle interface is decreased”, etc.

In particular, in a pyrolytic-graphite heating element produced by a CVD method, when a temperature history at the time of the film formation is changed, the crystalline orientation differs greatly, and thus, the electric ratio resistance also differs.

Thus, also when the heat treatment is performed after the production (formation), the orientation is changed, thereby increasing the anisotropy. As a result, it is highly probable that the resistance is decreased. It is very highly probable that the above-described resistance change can sufficiently occur not only in the pyrolytic graphite but also in other metallic materials.

The heat treatment can be performed simultaneously with the formation of an insulating ceramic protective layer when the resistance value of the produced (formed) conductive heating element can be predicted through experience, etc., and thus, the adjustment for decreasing the resistance can be performed without increasing unnecessary steps.

The temperature of the high-temperature heat treatment is in a range of 1000 to 2200° C. A material of the conductive heating element listed in the present invention will change little in a temperature range lower than this lower limit temperature.

In a temperature range higher than that, between the ceramic substrate and the conductive heating element, and the conductive heating element and the insulating ceramic protective layer, the both components are peeled off due to the heat stress occurring therebetween resulting from a difference in thermal expansion. Therefore, the temperature preferably is in a range of 1000 to 2200° C.

Further, in consideration of reducing a heat stress load at a high temperature or forming the insulating ceramic protective layer, the temperature range more preferably is of 1500 to 2000° C.

The resistance change rate in the temperature range of 1000 to 2200° C. is about 0.1 to 20%.

When the conductive heating element is pyrolytic graphite, boron-containing pyrolytic graphite, and silicon-containing pyrolytic graphite, it becomes possible to withstand the high-temperature heat treatment, and due to the heat treatment, various characteristics such as the crystallinity, the orientation, the crystallite size, and the density are changed, and thus, the resistance value is changed. Therefore, this is preferable.

With respect to the ceramic substrate, it is preferable to select oxide ceramics such as quartz and alumina, nitride ceramics such as nitride aluminum and nitride silicon, or a conductive heat-resistant substrate covered with an insulating layer such as an oxide film or a nitride film (for example, a substrate containing C or a metallic element), etc., because these can withstand a high-temperature heat treatment for a resistance adjustment, and also, preferable to select that which has a small difference in thermal expansion from the conductive heating element.

### EXAMPLES

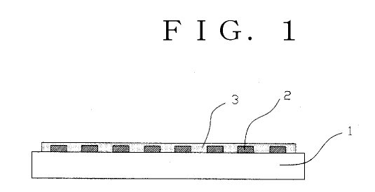

In the following preliminary experiments and examples, the ceramic heater shown in FIG. 1 was produced. In FIG. 1, reference numeral 1 denotes a ceramic substrate, 2 denotes a conductive heating element, and 3 denotes an insulating ceramic protective layer.

### First Preliminary Experiment

On a pyrolytic boron nitride substrate of 2 mm in thickness, methane gas was thermally decomposed under a vacuum condition of 1500° C. and 50 Torr to form a pyrolytic graphite layer of 100 μm in thickness. A heating pattern was machined on the resultant layer.

When the resistance value of the heating pattern composed of the pyrolytic graphite was measured by a four-proved method, the value was 8.56Ω. Subsequently, high-temperature heat treatment was performed for two hours under a vacuum condition of 50 Torr at each temperature shown in Table 1 between 900 and 2300° C. Thereafter, ammonia, boron trichloride, and methane gas were reacted under a vacuum condition of 1800° C. and 100 Torr to form carbon-containing pyrolytic boron nitride insulating layer of 100 μm in thickness, whereby the ceramic heater was produced.

Thereafter, the resistance value of the heating pattern was measured again by the four-proved method, the resistance value at each heat-treatment temperature was 8.56 to 6.74Ω. Measurement results of changes of these resistance values are listed in Table 1.

When the heat-treatment temperature was equal to or less than 900° C., there was little change in resistance value.

Further, it was confirmed that at equal to or more than 2300° C., one portion of the pattern was peeled off.

TABLE 1
Resistance Value Change Rates in [First Preliminary
Experiment]

| | | | Resistance | | |
|---|---|---|---|---|---|
| | Heat | | value after | | |
| | treatment | Resistance | heat | | |
| | temperature | value during | treatment | Change | |
| | (° C.) | formation (Ω) | (Ω) | rate (%) | Notes |
| Ex. 1 | 900 | 8.56 | 8.56 | 0.0 | |
| Ex. 2 | 1000 | Same as | 8.53 | 0.4 | |
| | | above | | | |
| Ex. 3 | 1200 | Same as | 8.40 | 1.9 | |
| | | above | | | |
| Ex. 4 | 1500 | Same as | 8.09 | 5.5 | |
| | | above | | | |
| Ex. 5 | 1800 | Same as | 7.61 | 11.1 | |
| | | above | | | |
| Ex. 6 | 2000 | Same as | 7.17 | 16.2 | |
| | | above | | | |
| Ex. 7 | 2200 | Same as | 6.90 | 19.4 | |
| | | above | | | |
| Ex. 8 | 2300 | Same as | 6.74 | 21.3 | Pattern |
| | | above | | | peeled |

### First Example

Using the first preliminary experiment as a reference, the ceramic heater was produced.

Similar to the first preliminary experiment, a pyrolytic graphite layer was formed on a pyrolytic boron nitride substrate of 2 mm in thickness, and the heating pattern was machined on the resultant layer.

When the resistance value of the heating pattern composed of the pyrolytic graphite was measured by a four-proved method, the value was 8.03Ω. A target resistance value was set to 7.10Ω (target resistance change rate was set to 11.6%), and the subsequent high-temperature heat treatment was performed at 1800° C.

At the temperature of 1800° C., the high-temperature heat treatment was performed for two hours under a vacuum condition of 50 Torr, and thereafter, ammonia, boron trichloride, and methane gas were reacted under a vacuum condition of 1800° C. and 100 Torr to form a carbon-containing pyrolytic boron nitride insulating layer of 100 μm in thickness, whereby the ceramic heater was produced.

Subsequently, the resistance value of the heating pattern was measured again by the four-proved method, the value was 7.15Ω (resistance change rate was 11.0%). Thus, it was possible to obtain a resistance value close to the target value of 7.10Ω.

### Second Preliminary Experiment

On a pyrolytic boron nitride substrate of 2 mm in thickness, boron trichloride and methane gas were thermally decomposed under a vacuum condition of 1500° C. and 50 Torr to form a boron-containing pyrolytic graphite layer of 100 μm in thickness. A resistance value of a heating pattern composed of the boron-containing pyrolytic graphite was measured by a four-proved method, and the value was 7.89Ω.

Subsequently, similar to the first preliminary experiment, the ceramic heater was produced, and the resistance value changed by the heat treatment at each temperature shown in Table 2 was 7.89 to 6.14Ω.

The results of the resistance value change are listed in Table 2.

When the heat-treatment temperature was equal to or less than 900° C., there was little change in resistance value. Further, it was confirmed that at equal to or more than 2300° C., one portion of the pattern was peeled off.

TABLE 2
Resistance Value Change Rates in [Second Preliminary
Experiment]

| | | | Resistance | | |
|---|---|---|---|---|---|
| | Heat | | value after | | |
| | treatment | Resistance | heat | | |
| | temperature | value during | treatment | Change | |
| | (° C.) | formation (Ω) | (Ω) | rate (%) | Notes |
| Ex. 11 | 900 | 7.89 | 7.89 | 0.0 | |
| Ex. 12 | 1000 | Same as | 7.87 | 0.3 | |
| | | above | | | |
| Ex. 13 | 1200 | Same as | 7.77 | 1.5 | |
| | | above | | | |
| Ex. 14 | 1500 | Same as | 7.36 | 6.7 | |
| | | above | | | |
| Ex. 15 | 1800 | Same as | 7.02 | 11.0 | |
| | | above | | | |
| Ex. 16 | 2000 | Same as | 6.63 | 16.0 | |
| | | above | | | |
| Ex. 17 | 2200 | Same as | 6.33 | 19.8 | |
| | | above | | | |
| Ex. 18 | 2300 | Same as | 6.14 | 22.2 | Pattern |
| | | above | | | peeled |

### Second Example

Using the second preliminary experiment as a reference, the ceramic heater was produced.

Similar to the second preliminary experiment, a boron-containing pyrolytic graphite layer of 100 μm in thickness was formed on a pyrolytic boron nitride substrate of 2 mm in thickness, and the heating pattern was machined on the resultant layer. A resistance value of the heating pattern composed of the boron-containing pyrolytic graphite was measured by a four-proved method, and the value was 7.12Ω.

A target resistance value was set to 6.65Ω (target resistance change rate was set to 6.6%), and the subsequent high-temperature heat treatment was performed at 1500° C. At the temperature of 1500° C., the high-temperature heat treatment was performed for two hours under a vacuum condition of 50 Torr, and thereafter, ammonia, boron trichloride, and methane gas were reacted under a vacuum condition of 1800° C. and 100 Torr to form a carbon-containing pyrolytic boron nitride insulating layer of 100 μm in thickness, whereby the ceramic heater was produced.

Subsequently, the resistance value of the heating pattern was measured again by the four-proved method, the value was 6.55Ω (resistance change rate was 8.0%). Thus, it was possible to obtain the resistance value close to the target value of 6.65Ω.

It is noted that in the embodiment, only the examples in which the pyrolytic graphite and the boron-containing pyrolytic graphite are used for the conductive heating element are shown. However, when silicon-containing pyrolytic graphite was used, the similar result was obtained.

It was also confirmed that in the ceramic substrate, the resistance change of the conductive heating element by the high-temperature heat treatment occurred even in alumina other than pyrolytic boron nitride or a nitride aluminum substrate.

1. A ceramic heater, comprising:
a ceramic substrate; and
a conductive heating element arranged inside of or on a surface of the ceramic substrate, wherein
said conductive heating element is made of a material which had undergone a high-temperature heat treatment.

2. The ceramic heater according to claim 1, wherein a temperature of the high-temperature heat treatment is in a range of 1000 to 2200° C.

3. The ceramic heater according to claim 1, wherein the resistance value of the conductive heating element is 0.1 to 20% lower than that of the same conductive heating element before the heat treatment.

4. The ceramic heater according to claim 1, wherein the conductive heating element is any one of pyrolytic graphite, boron-containing pyrolytic graphite, and silicon-containing pyrolytic graphite.

5. The ceramic heater according to claim 1,
wherein the ceramic substrate is oxide ceramic, nitride ceramic, or a heat resistant substrate covered with an insulating layer such as an oxide film or a nitride film.

6. A method of manufacturing a ceramic heater which comprises a ceramic substrate and a conductive heating element arranged inside of or on a surface of the ceramic substrate, the method comprising a step of adjusting a resistance value of the conductive heating element by performing high-temperature heat treatment.

7. The method of manufacturing a ceramic heater according to claim wherein the high-temperature heat treatment of the conductive heating element is performed continuously or simultaneously with a formation processing step of an insulating protective layer.
